(19) United States
(12) Patent Application Publication
(10) Pub. No.: US 2008/0134298 A1
(43) Pub. Date: Jun. 5, 2008

(54) Integrated development environment with community integration

(75) Inventors: Adam D. Nathan, Kirkland, WA (US); John I. Montgomery, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/633,340

(22) Filed: Dec. 4, 2006

(51) Int. Cl. G06F 9/44; G06F 21/22

(52) U.S. Cl. 726/4; 717/101; 726/21

(57) ABSTRACT

Various technologies and techniques are disclosed for providing an intergrated development environment with community integration. A user specifies access settings to indicate that one or more other users will be allowed to access his development projects and with what permissions. Input is received from the user to save a development project. Upon saving the development project, the development project is automatically made available for sharing with others in a circle of friends with the first user. A common infrastructure can be used for providing the integrated development environment and the social network. The user identity system, authentication/authorization system, ratings system, and storage can be shared by the integrated development environment and the social network.

### BACKGROUND

Today when developers create projects and want to share them with other developers, particularly with the broader community rather than just their workgroup or their company, they must go through a manual process of saving their projects and uploading them to a central collaboration server. This process can be tedious and frustrating, particularly since these collaboration servers tend to have very different user experiences than the tools the developers are using and because they are not well integrated into the development experience.

### SUMMARY

Various technologies and techniques are disclosed for providing an integrated development environment with community integration. A user specifies access settings to indicate that one or more other users will be allowed to access his development projects and with what permissions. Input is received from the user to save a development project. Upon saving the development project, the development project is automatically made available for sharing with others in a circle of friends with the user.

In one implementation, a common infrastructure can be used for providing the integrated development environment and the social network. The user identity system, authentication/authorization system, ratings system, and storage can be shared by the integrated development environment and the social network.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of an IDE with community integration application of one implementation.

FIG. 3 is a high-level process flow diagram for one implementation of the system of FIG. 1.

FIG. 4 is a process flow diagram for one implementation of the system of FIG. 1 illustrating the stages involved in integrating development project saving and sharing.

FIG. 5 is a process flow diagram for one implementation of the system of FIG. 1 illustrating the stages involved in controlling which users can access development projects of another.

FIG. 6 is a simulated screen for one implementation of the system of FIG. 1 that illustrates providing an integrated development environment with community integration.

FIG. 7 is a simulated screen for one implementation of the system of FIG. 1 that illustrates some exemplary community integration features of the integrated development environment.

FIG. 8 is a simulated screen for one implementation of the system of FIG. 1 that illustrates saving a project to the integrated development and the community simultaneously.

FIG. 9 is a diagrammatic view of a computer system of one implementation that provides one or more components of the system of FIG. 1.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as a software development application, but the system also serves other purposes in addition to these. In one implementation, one or more of the techniques described herein can be implemented as features within a software development program such as MICROSOFT® VISUAL STUDIO®, Eclipse, Macromedia Dreamweaver, or from any other type of program or service that allows a user to create software for one or more operating system platforms. In one implementation, a software development application is provided that has community integration. In the software development application, sharing and collaboration are a central part of the experience. In one implementation, the development environment (the place where developers write code) and the social network (collaboration server or network of servers) are so deeply integrated that they are virtually inseparable: to save a project is to save it to the network and to share it with others, and to visit the network is to launch the development environment.

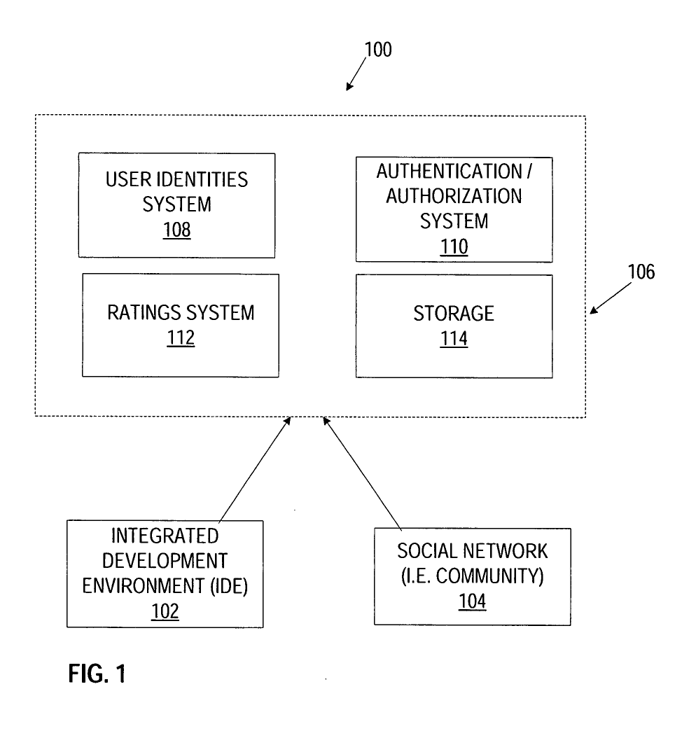

FIG. 1 illustrates a system 100 that has an integrated development environment (IDE) 102 with a social network (i.e. community integration) 104. In one implementation, IDE 102 and social network 104 share a common infrastructure 106, such as user identities system 108, authentication/authorization system 110, ratings system 112, and/or storage 114. In one implementation, by sharing a common infrastructure, the two environments can be tightly integrated together in a way that makes a user feel like they are working on a single environment.

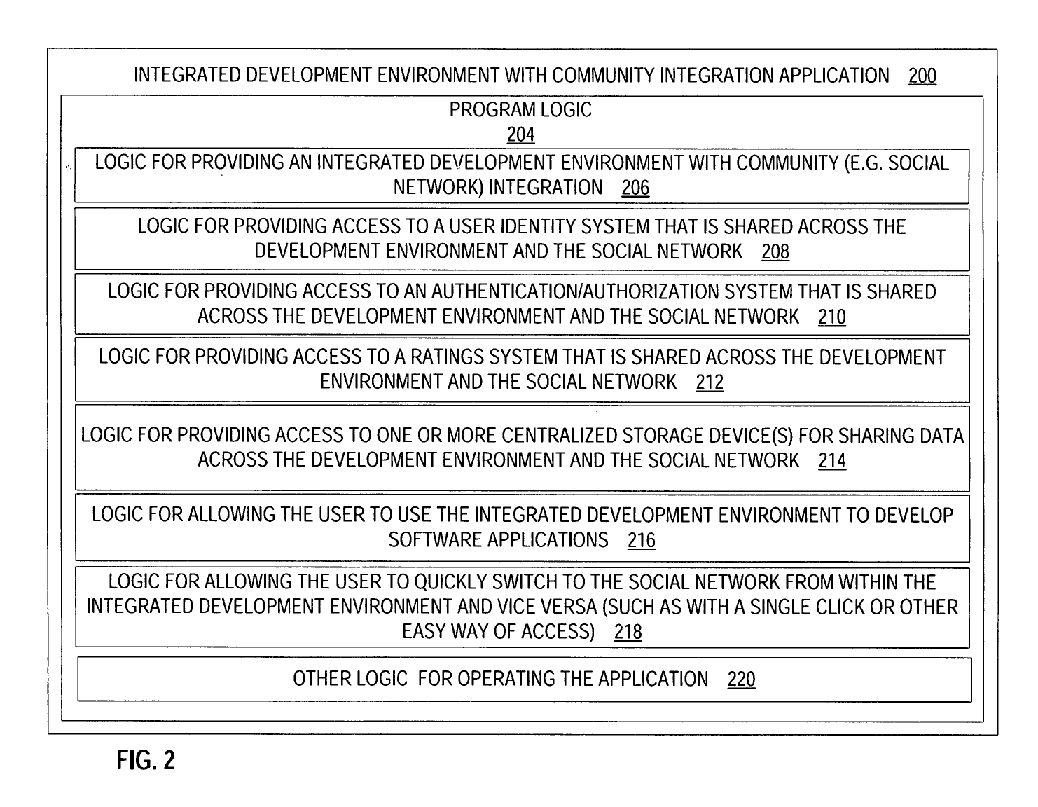

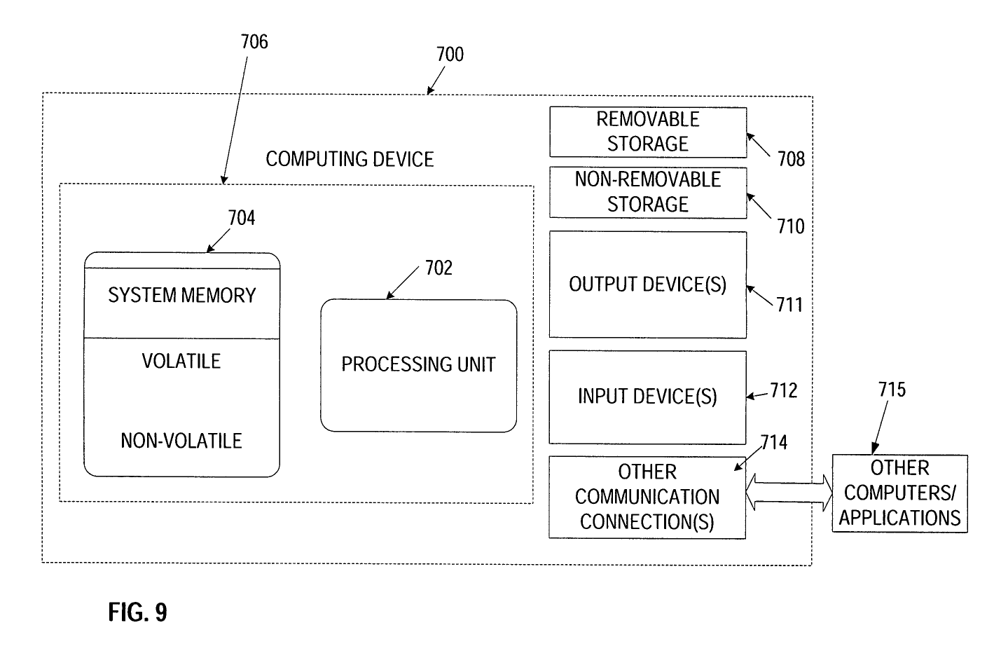

Turning now to FIG. 2 with continued reference to FIG. 1, an IDE with community integration application 200 operating with system 100 is illustrated. In one implementation, IDE with community integration application 200 is one of the application programs that reside on computing device 700 (in FIG. 9). However, it will be understood that IDE with community integration application 200 can alternatively or additionally be embodied as computer-executable instructions on one or more computers and/or in different variations than shown on FIGS. 1 and 9. Alternatively or additionally, one or more parts of IDE with community integration application 200 can be part of system memory 704 (on FIG. 9), on other computers and/or applications 715 (on FIG. 9), or other such variations as would occur to one in the computer software art.

IDE with community integration application 200 includes program logic 204, which is responsible for carrying out some or all of the techniques described herein. Program logic 204 includes logic for providing access to an integrated development environment with community (e.g. social network) integration 206; logic for providing access to a user identity system that is shared across the development environment and the social network 208; logic for providing access to an authentication/authorization system that is shared across the development environment and the social network 210; logic for providing access to a ratings system that is shared across the development environment and the social network 212; logic for providing access to one or more centralized storage device(s) for sharing data across the development environment and the social network 214; logic for allowing the user to use the integrated development environment to develop software applications 216; logic for allowing the user to quickly switch to the social network from within the integrated development environment and vice versa (such as with a single click or other easy way of access) 218; and other logic for operating the application 220. In one implementation, program logic 204 is operable to be called programmatically from another program, such as using a single call to a procedure in program logic 204.

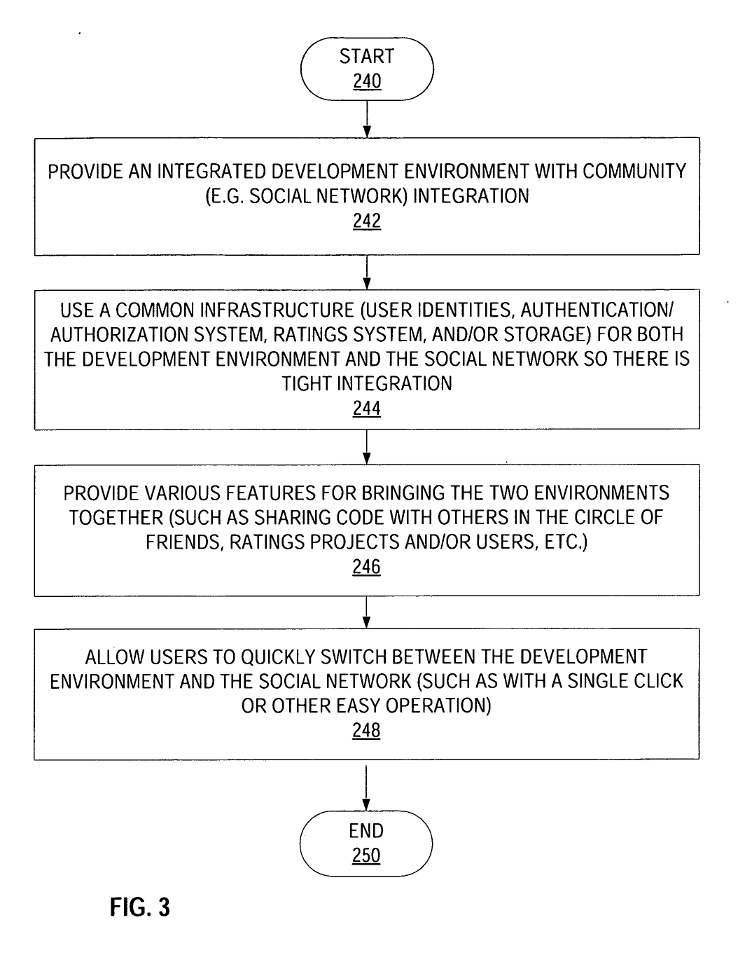

Turning now to FIGS. 3-5 with continued reference to FIGS. 1-2, the stages for implementing one or more implementations of IDE with community integration application 200 are described in further detail. FIG. 3 is a high level process flow diagram for IDE with community integration application 200. In one form, the process of FIG. 3 is at least partially implemented in the operating logic of computing device 700 (on FIG. 9). The procedure begins at start point 240 with providing an integrated development environment with community (e.g. social network) integration (stage 242). A common infrastructure is used (e.g. user identities, authentication/authorization system, ratings system, and/or storage) for both the development environment and the social network so there is tight integration (stage 244). Various features are provided for bringing the two environments together, such as sharing code with others in the circle of friends, project and user ratings, etc. (stage 246). Users can quickly switch between the development environment and the social network, such as with a single click or another easy operation (stage 248). The process ends at end point 250.

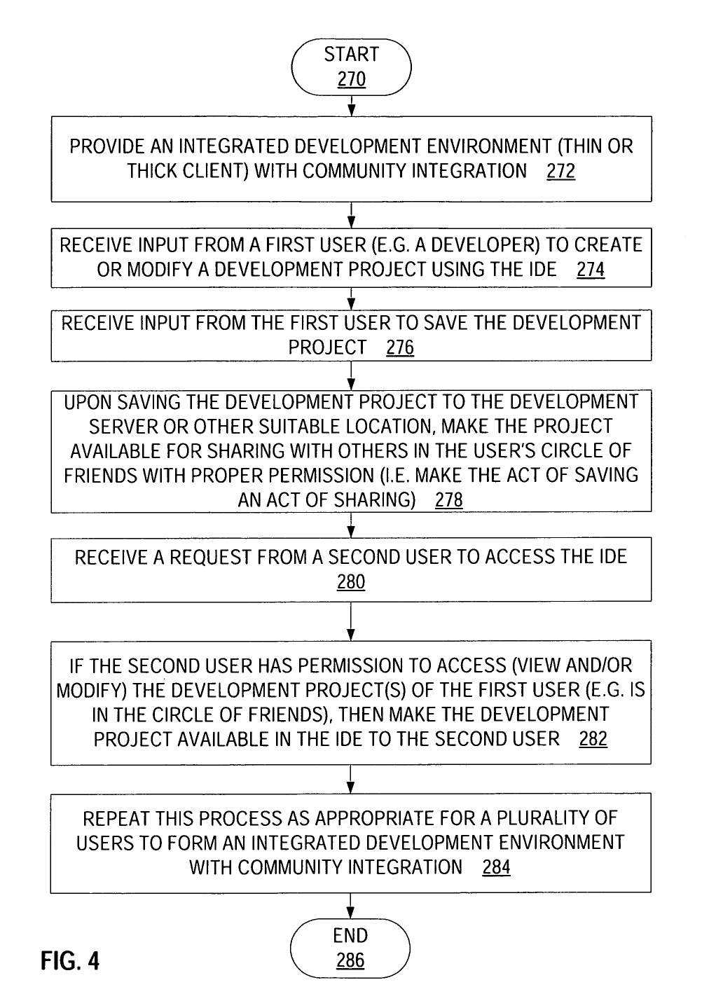

FIG. 4 illustrates one implementation of the stages involved in integrating development project saving and sharing. In one form, the process of FIG. 4 is at least partially implemented in the operating logic of computing device 700 (on FIG. 9). The procedure begins at start point 270 with providing an integrated development environment (thin or thick client) with community integration (stage 272). Input is received from a first user (e.g. a developer) to create or modify a development project using the IDE (stage 274). Input is received from the first user to save the development project (stage 276). Upon saving the development project to the development server or other suitable location, the project is made available for sharing with others in the user's circle of friends with proper permission (i.e. the act of saving is made an act of sharing) (stage 278). A request is received from a second user to access the IDE (stage 280). If the second user has permission to access (view and/or modify) the development project(s) of the first user (e.g. is in the circle of friends), then the development project(s) of the first user are made available in the IDE to the second user (stage 282). This process can be repeated as appropriate for a plurality of users to form an integrated development environment with community integration (stage 284). The process ends at end point 286.

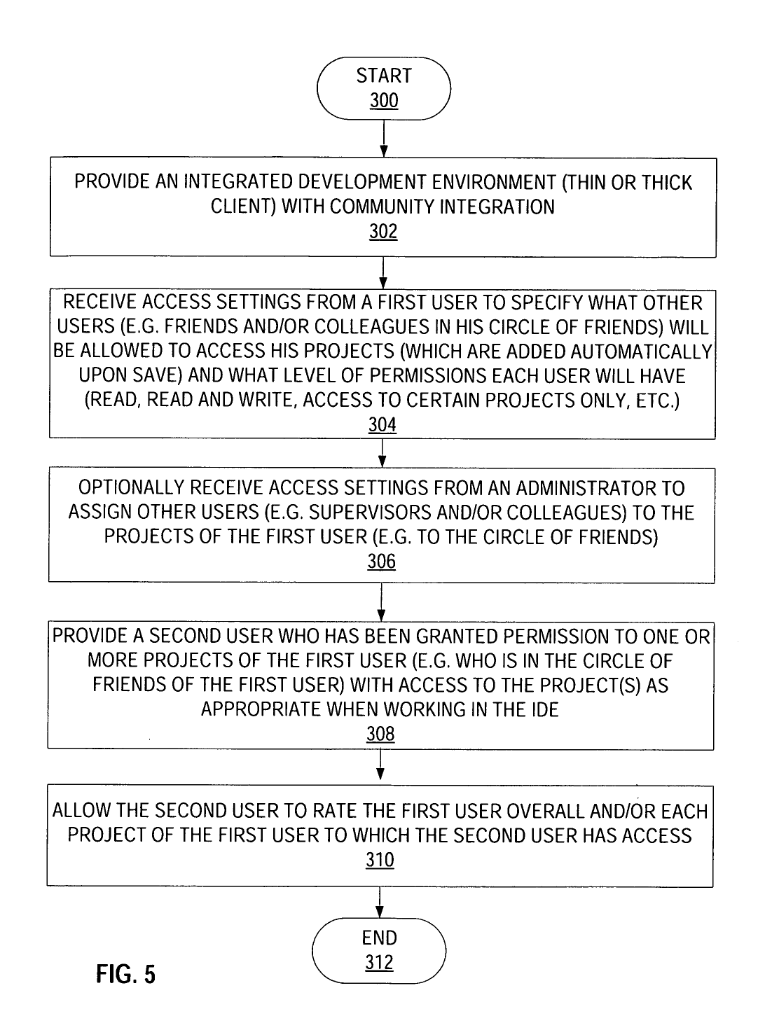

FIG. 5 illustrates one implementation of the stages involved in controlling which users can access development projects of another. In one form, the process of FIG. 5 is at least partially implemented in the operating logic of computing device 700 (on FIG. 9). The procedure begins at start point 300 with providing an integrated development environment (thin or thick client) with community integration (stage 302). Access settings are received from a first user to specify what other users (e.g. friends and/or colleagues in his circle of friends) will be allowed to access his projects (which are added to the social network automatically upon save) and what level of permissions each user will have (read, read and write, access to certain projects only, etc.) (stage 304). In one implementation, access settings can optionally be received from an administrator to assign other users (e.g. supervisors and/or colleagues) to the projects of the first user (e.g. to the circle of friends) (stage 306). A second user who has been granted permission to one or more projects of the first user (e.g. who is in the circle of friends of the first user) is provided with access to the project(s) as appropriate when working in the IDE (stage 308). The second user is allowed to rate the first user overall and/or each project of the first user to which the second user has access (stage 310). By providing a rating system for the user and/or his software development projects, other users in the circle of friends can see the opinions of others about the particular user's work. The process ends at end point 312.

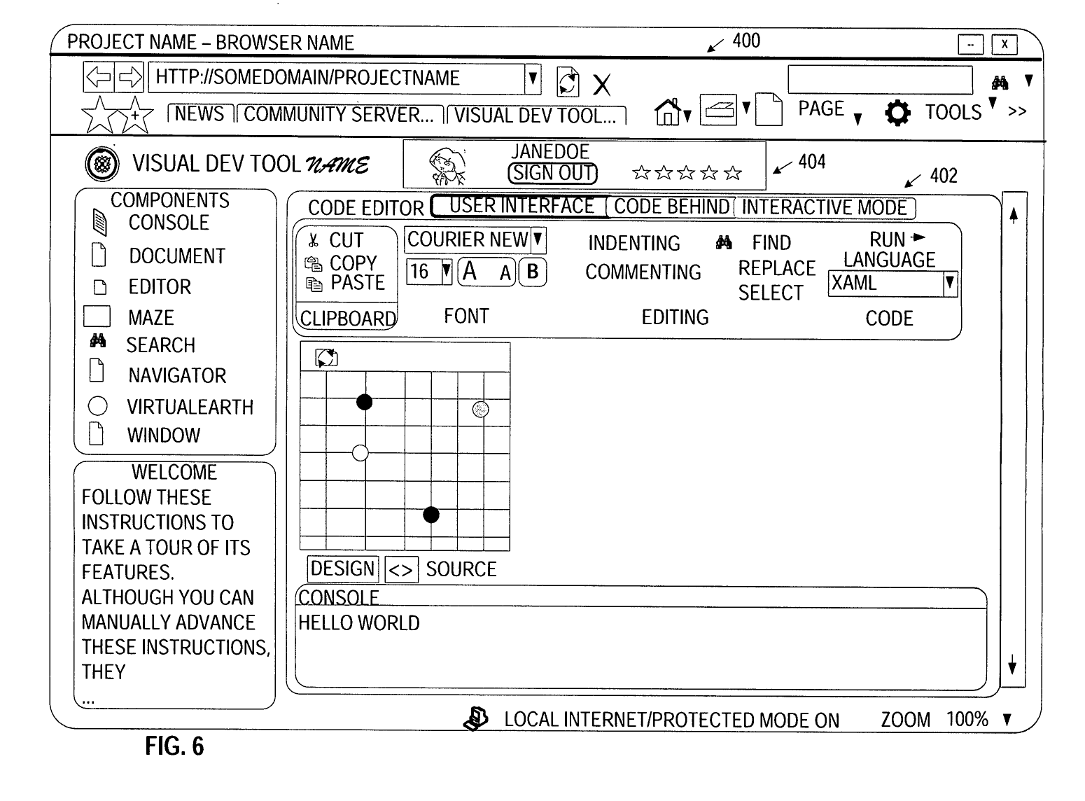

Turning now to FIGS. 6-8, simulated screens are shown to illustrate exemplary user interface layouts for portions of IDE with community integration application 200 described in the stages of FIGS. 3-5. These screens can be displayed to users on output device(s) 111. Furthermore, these screens can receive input from users from input device(s) 112.

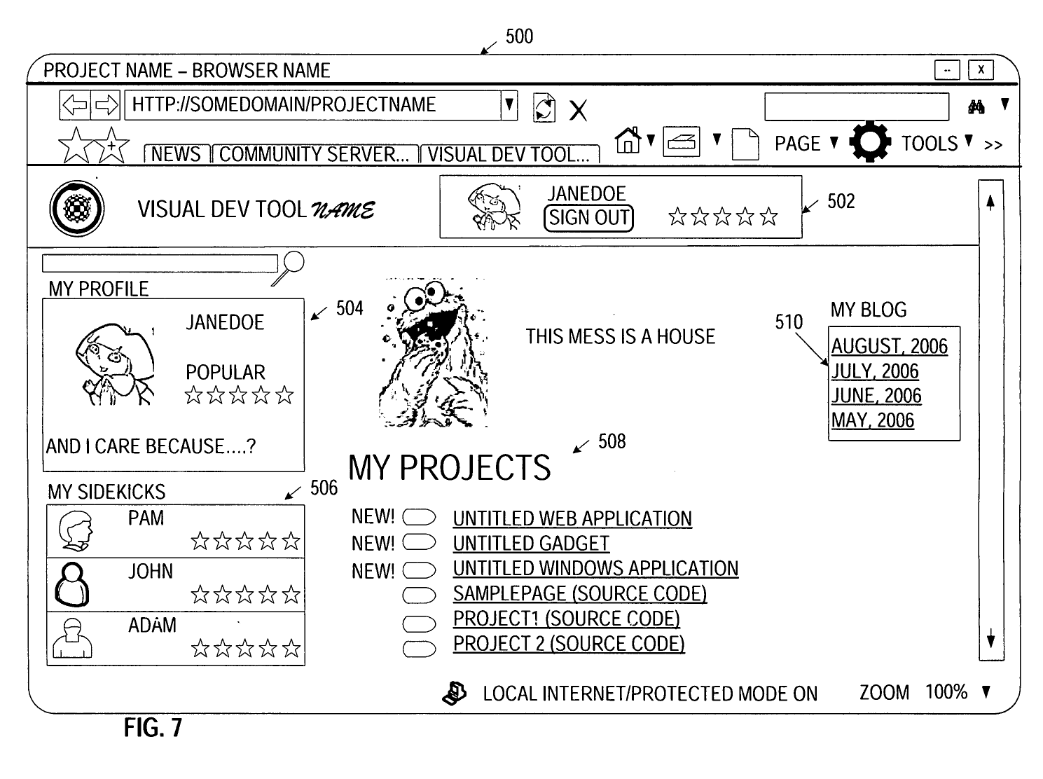

FIG. 6 is a simulated screen 400 for one implementation that illustrates providing an integrated development environment with community integration. Code editor 402 is provided for allowing a developer to create and modify a given development project. The user is shown as logged in to the environment, as indicated by the sign in section 404. Turning now to FIG. 7, a simulated screen 500 illustrates some additional community integration features of the integrated development environment. Sign in section 502 (404 in FIG. 6) is again displayed, along with the user's profile 504, the user's circle of friends 506, the user's software development projects 508, and the user's blog 510. The user profile 504 can be modified to specify various development and social network preferences. The circle of friends 506 can be modified to specify who is allowed to access the projects of the user, and what level of access they can have. The development projects section 508 can be used to quickly access recent projects that the user has created. The user can also access the projects and/or other details regarding others in his circle of friends by selecting the particular friend in the circle of friends list 506 to view more information about that friend.

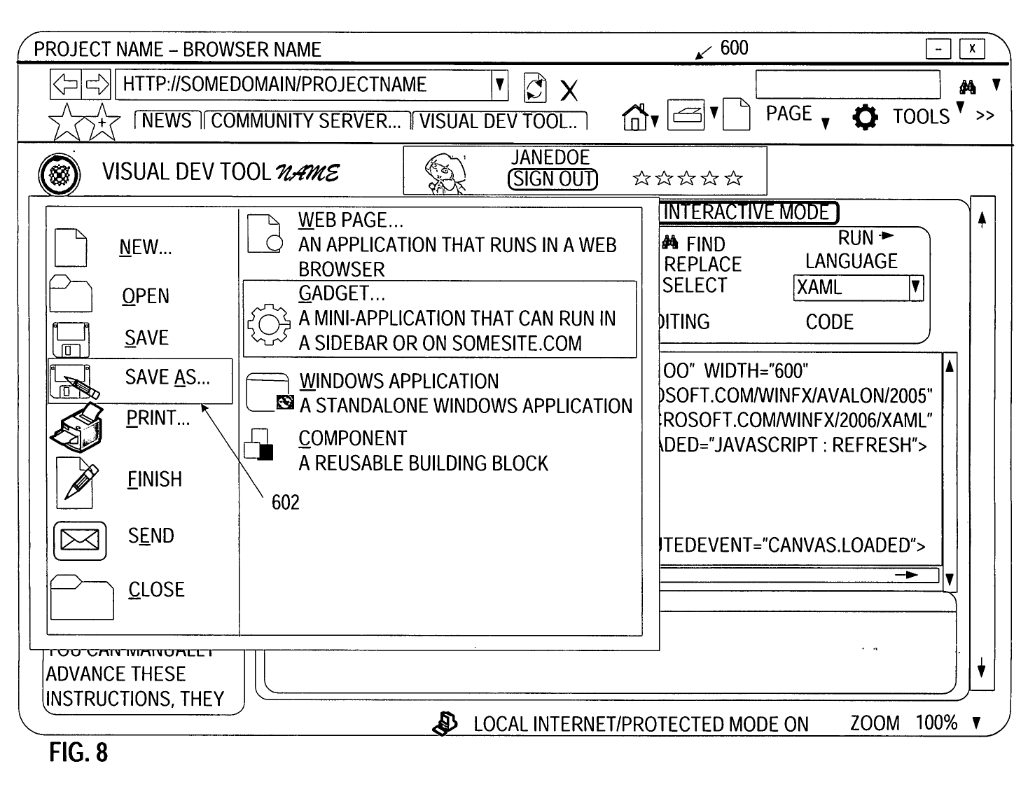

Shown in FIG. 8 is a simulated screen 600 that illustrates saving a project to the integrated development and the community simultaneously. As described in more detail in the stages of FIG. 4, when the user saves a development project using a save option 602 (stage 276), the project is made available for sharing in the social network automatically (stage 278).

As shown in FIG. 9, an exemplary computer system to use for implementing one or more parts of the system includes a computing device, such as computing device 700. In its most basic configuration, computing device 700 typically includes at least one processing unit 702 and memory 704. Depending on the exact configuration and type of computing device, memory 704 may be volatile (such as RAM), non-volatile (such as ROM, flash memory, etc.) or some combination of the two. This most basic configuration is illustrated in FIG. 9 by dashed line 706.

Additionally, device 700 may also have additional features/functionality. For example, device 700 may also include additional storage (removable and/or non-removable) including, but not limited to, magnetic or optical disks or tape. Such additional storage is illustrated in FIG. 9 by removable storage 708 and non-removable storage 710. Computer storage media includes volatile and nonvolatile, removable and non-removable media implemented in any method or technology for storage of information such as computer readable instructions, data structures, program modules or other data. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 700. Any such computer storage media may be part of device 700.

Computing device 700 includes one or more communication connections 714 that allow computing device 700 to communicate with other computers/applications 715. Device 700 may also have input device(s) 712 such as keyboard, mouse, pen, voice input device, touch input device, etc. Output device(s) 711 such as a display, speakers, printer, etc. may also be included. These devices are well known in the art and need not be discussed at length here. In one implementation, computing device 700 includes some or all parts of IDE with community integration application 200.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for providing an integrated development environment with community integration comprising the steps of:
providing an integrated development environment with community integration;
receiving input from a first user to save a development project; and
upon saving the development project, automatically making the development project available for sharing with others in a circle of friends with the first user.

2. The method of claim 1, wherein the integrated development environment is provided in a thin client.

3. The method of claim 1, wherein the integrated development is provided in a thick client.

4. The method of claim 1, further comprising:
receiving a request from a second user to access the integrated development environment.

5. The method of claim 4, further comprising:
determining that the second user has permission to view the development project of the first user.

6. The method of claim 5, further comprising:
making the development project of the first user available to the second user in the integrated development environment.

7. The method of claim 6, wherein the second user can specify ratings regarding the first user.

8. The method of claim 6, wherein the second user can specify ratings for the development project of the first user.

9. A computer-readable medium having computer-executable instructions for causing a computer to perform the steps recited in claim 1.

10. A computer-readable medium having computer-executable instructions for causing a computer to perform steps comprising:
provide access to a user identity system that is shared across a development environment and a social network;
provide access to an authentication/authorization system that is shared across the development environment and the social network;
provide access to a ratings system that is shared across the development environment and the social network; and
provide access to at least one storage device that is used to share data across the development environment and the social network.

11. The computer-readable medium of claim 10, further having computer-executable instructions for causing a computer to perform the step comprising:
allow a user of the development environment to develop a software application.

12. The computer-readable medium of claim 10, further having computer-executable instructions for causing a computer to perform the step comprising:
allow a user of the development environment to quickly switch to the social network from within the development environment.

13. The computer-readable medium of claim 10, wherein the development environment is operable to run as a thin client.

14. The computer-readable medium of claim 10, wherein the development environment is operable to run as a thick client.

15. A method for sharing user projects in an integrated development environment with community integration comprising the steps of:
providing an integrated development environment with community integration;
receiving access settings from a first user to specify that one or more other users will be allowed to access at least one development project of the first user and to specify what level of permissions the one or more users will have to the development project; and
each time the first user saves a new development project in the integrated development environment, automatically making the new development project available to the one or more other users based on the access settings specified by the first user.

16. The method of claim 15, wherein the one or more other users are allowed to provide a rating for the at least one development project of the first user from within the integrated development environment.

17. The method of claim 15, wherein the integrated development environment is provided as a thin client.

18. The method of claim 15, wherein the integrated development environment is provided as a thick client.

19. The method of claim 15, further comprising:
receiving additional access settings from an administrator to assign additional users that will be allowed to access the at least one development project of the first user.

20. A computer-readable medium having computer-executable instructions for causing a computer to perform the steps recited in claim 15.
